(19) United States
(12) Patent Application Publication
(10) Pub. No.: US 2015/0169321 A1
(43) Pub. Date: Jun. 18, 2015

(54) System And Method For Generating Compliance Information For A Build-System Product

(71) Applicant: 2236008 Ontario Inc., Waterloo (CA)

(72) Inventors: Keith Roderick Rissell, Arnprior (CA); Eric Anthony Johnson, Stittsville (CA); Michael Paul Michalyshyn, Nepean (CA)

(21) Appl. No.: 14/404,523

(22) PCT Filed: May 31, 2013
(86) PCT No.: PCT/CA2013/000546

§ 371 Date: Nov. 28, 2014

Related U.S. Application Data
(63) Continuation-in-part of application No. 13/486,113, filed on Jun. 1, 2012.

(30) Foreign Application Priority Data
Jun. 1, 2012 (EP) 12170433.2

(51) Int. Cl. G06F 9/44

(52) U.S. Cl. CPC G06F 8/71

(57) ABSTRACT

Systems and methods for generating compliance information for a build-system product are described. The compliance information is associated with one or more source code files used to build the build-system product. Tracking information is created for the build-system product including a source code identifier for each source code file that contributes to the build-system product. The tracking information may be utilized to identify the source codes files that contributed to the build-system product and identify the associated compliance information.

### TECHNICAL FIELD

The current disclosure relates to generation of software programs in a software build system, and in particular relates to a system and method for generating compliance information for a build-system product of the software build system.

### BACKGROUND

Various types of compliance information can be associated with software source code files. The compliance information can include, for example, software license terms, distribution restrictions, export restrictions, intellectual property rights identifiers and other similar information.

Application and enforcement of this compliance information may extend to executable or binary files derived from the source code files as well. The executable and binary files are derived from one or more source code files by a build system. In many build systems the build-system products such as an executable and binary files do not preserve an indication of which source code files contributed to the executable and binary files and therefore identifying the compliance information that applies to the executable and binary files is problematic.

Therefore there is a need for an improved system and method for generating compliance information for a build-system product.

### BRIEF DESCRIPTION OF THE DRAWINGS

Further features and advantages of the present disclosure will become apparent from the following detailed description, taken in combination with the appended drawings, in which:

FIG. 1 depicts a system for generating compliance information;

FIG. 2 depicts components of a compliance information generating system;

FIG. 3 depicts the association of source code identifiers and compliance information;

FIG. 4 depicts components of a system for generating compliance information associated with build-system product;

FIG. 5 depicts a method of associating compliance information from a plurality of source code files with build-system product; and

FIG. 6 depicts a method of generating compliance information associated with build-system product.

### DETAILED DESCRIPTION

In accordance with an aspect of the present disclosure there is provided a method, executable on one or more processors, for tracking generating compliance information for a build-system product associated with a plurality of source code files that contribute to building a build-system product, the method comprising: generating a unique compliance identifier for each of a plurality of compliance information items; and associating one or more compliance identifiers with each of a plurality of source code file identifiers and storing the associations in source-compliance mapping information; creating tracking information related to the build-system product, the tracking information including a source code identifier for each of the plurality of source code files that contribute to the building of the build-system product; and retrieving compliance information items for the build-system product using the tracking information and the source-compliance mapping information to identify the compliance information items associated with the plurality of source code files that contributed to the building of the build-system product.

In accordance with another aspect of the present disclosure there is provided a system for tracking generating compliance information associated with a plurality of source code files that contribute to for a build-system product, the system comprising: a compliance information repository containing a unique compliance identifier for each of a plurality of compliance information items each retrievable using a unique compliance identifier; a source code repository containing the plurality of source code files used for creating the build-system product; a source-compliance mapping repository containing a plurality of records each associating a source code file identifier with one or more compliance identifiers and retrievable using the respective source code file identifier, where the one or more compliance identifiers in each record correspond to compliance information items associated with the source code file corresponding to the respective source code file identifier, each of the plurality of source code files having an associated one or more compliance identifiers from the compliance information repository; and a build component for creating tracking information related to the build-system product, the tracking information including a source code identifier for each of the plurality of source code files to identify a respective source code file that contributes to the building of the build-system product; and an association mechanism retrieving compliance information items for the build-system product using the tracking information and the source-compliance mapping repository records to identify the compliance information items associated with the plurality of source code files that contributed to the building of the build-system product.

In accordance with yet another aspect of the present disclosure there is provided a computer readable memory containing instructions for execution on one or more processors, the instructions for tracking generating compliance information associated with a plurality of source code files that contribute to for a build-system product, the instructions comprising: generating a unique compliance identifier for each of a plurality of compliance information items; and associating one or more compliance identifiers with each of a plurality of source code file identifiers and storing the associations in source-compliance mapping information; creating tracking information related to the build-system product, the tracking information including a source code identifier for each of the plurality of source code files that contribute to the building of the build-system product: and retrieving compliance information items for the build-system product using the tracking information and the source-compliance mapping information to identify the compliance information items associated with the plurality of source code files that contributed to the building of the build-system product.

One or more of source code files, or object files used to build a build-system product may have associated terms, conditions or restrictions on their use, distribution, or redistribution, that need to be complied with. A build-system product built from these source or object files may inherit the terms, conditions, or restrictions. For example, a source code file may provide encryption functionality, which may have various government export restrictions that must be complied with. A build-system product built using the encryption functionality source code file may inherit these export restrictions. Similarly, a source code file may be associated with intellectual property, for example code that may be covered under patent, copyright or trademark licenses may have various restrictions that must be complied with in order to use the source code file. The use and re-distribution of source code contained in a source code file may be governed by one or more software license agreements including, for example, commercial software licensing agreements, open source licenses or free software licenses. The use and re-distribution restrictions may include ineligibility for commercial distribution, restricted disclosure, limitation to certain target platforms, restriction to certain geographic regions, and restriction to certain vertical markets, royalty payments due and other similar restrictions. A build-system product built from source code files having various terms, conditions or restrictions may inherit the terms, conditions or restrictions of the source code files. The terms, conditions or restrictions may need to be complied with in order to use, modify and/or distribute the built build-system product, or the files associated with building the build-system product. The information indicating the various terms, conditions and/or restrictions associated with a source code file is referred to herein as compliance information. The information indicating the various terms, conditions and/or restrictions (a.k.a. compliance information) inherited by a build-system product built from contributing source code files may be represented in the form of a license guide or other similar document.

Systems and methods are described herein that are used in generating compliance information for a build-system product. The generation of the compliance information may comprise associating compliance information of source code files and/or object files with a build-system product. The build-system product may be built from a sub-set of possible source code files and/or previously compiled object files. It may be difficult or impractical to explicitly specify all of the source code files or object files used in building a particular build-system product. As such, the build process is able to determine required source code files or object files to include in the build process. For example, a build-system product may be built by specifying one or more source code files or object files and their associated versions to include when building a build-system product. The build process may then determine additional source code files or object files that need to be included based on, for example, dependency relationships of the specified source code files and object files. As will be appreciated, if different source code files and/or object files are specified, or even simply different versions, the source code files and object files included in building the build-system product may vary.

The compliance information of source code files and/or object files used to build a build-system product can be associated with the built build-system product. The compliance information associated with a build-system product built according to the systems and methods described herein can be derived from the source code files and/or object files used in the build process. As an example, a build-system product may be built from source code files covered by two different software licenses. When the build-system product is built according to the present systems and methods the resultant compliance information for the build-system product can be generated using the compliance information associated with the source code files used to create the build-system product. The systems and method may be used to generate, for example, a software license guide for the build-system product.

The compliance information associated with individual source or object files, including individual versions of the source and object files, can be associated with one or more build-products that results from the build system processing the source and/or object files. The build-system product may include one or more of each of a linked binary, a library, a component, a package, a debug file or other output of a build process.

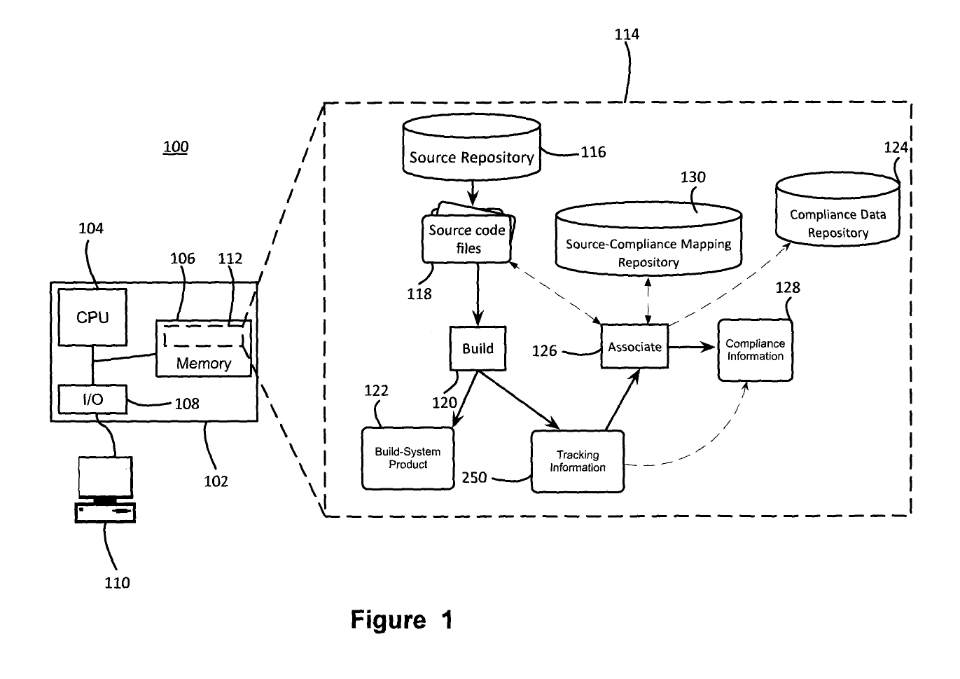

FIG. 1 depicts a system for generating compliance information for a build-system product. The illustrative system 100 as depicted comprises a computing system 102 comprising a central processing unit (CPU) 104 coupled to memory 106 and an input/output (I/O) interface 108. A display 110 may be connected to the computing system 102. The computing device 102 may be, for example, a development workstation used by a developer when developing a build-system product or part of a dedicated software build (a.k.a. software configuration management) environment. The memory 106 stores instructions 112, that when executed by the CPU 104, configure the computing system 102 to provide functionality 114 for generating compliance information. The generation of the compliance information may include deriving which of the one or more source code files and/or object files contributed to the building the build-system product and associating compliance information of one or more source code files and/or object files with a build-system product.

The system for generating compliance information for a build-system product, 114 may include various components. For example a source repository 116 may store a plurality of source code files 118, each of which may have various different versions. One or more of the source code files, or previously compiled object files, stored in the repository may be retrieved 118 and used by a build system 120 to generate one or more build-system products 122. As described further herein, the build-system product 122 may have associated tracking information 250. One or more of the source code files 118 used in building the build-system product 122 is associated with compliance information that may be stored in a compliance data repository 124. A source-compliance mapping repository 130 contains records that provide mapping between a sub-set (which may included all) of the one or more source code files 118, each having associated compliance information, and identifiers of the compliance information associated with the respective source code files. Reference to individual source code files includes different versions of the same source code file that may each have different associated compliance information. The mapping of source code file to compliance information may be in the form of associating source code file identifiers with compliance information identifiers that may be used as a key to look-up compliance information in the compliance data repository 124.

An associate tool 126 can be used to determine compliance information 128 associated with a build-system product 122 using the tracking information 250. The associate tool 126 may determine the tracking information 250 associated with the build-system product 122 and use source file identifiers determined from tracking information 250 to identify and retrieve the compliance information 128 from the compliance data repository 124.

As set forth above, the compliance information generating functionality 114 may be used to identify compliance information 128 associated with a build-system product 122. The compliance information 128 may be various information indicating terms, conditions or restrictions that should or must be complied with. For example, the compliance information may include one or more of licensing information, export control information, or patent information.

Although depicted as having a single CPU 104 and associated memory 106, the computing system 102 may be provided by multiple processors or multiple computing devices connected together. Further, the various components of the compliance information generating system 100 may be provided by separate computing systems. For example, the source code repository 116 may be provided on a server, while the build tool 120, providing function such as a complier, assembler and linker to create the build-system product 122, may be provided on a developer's workstation or software configuration management server.

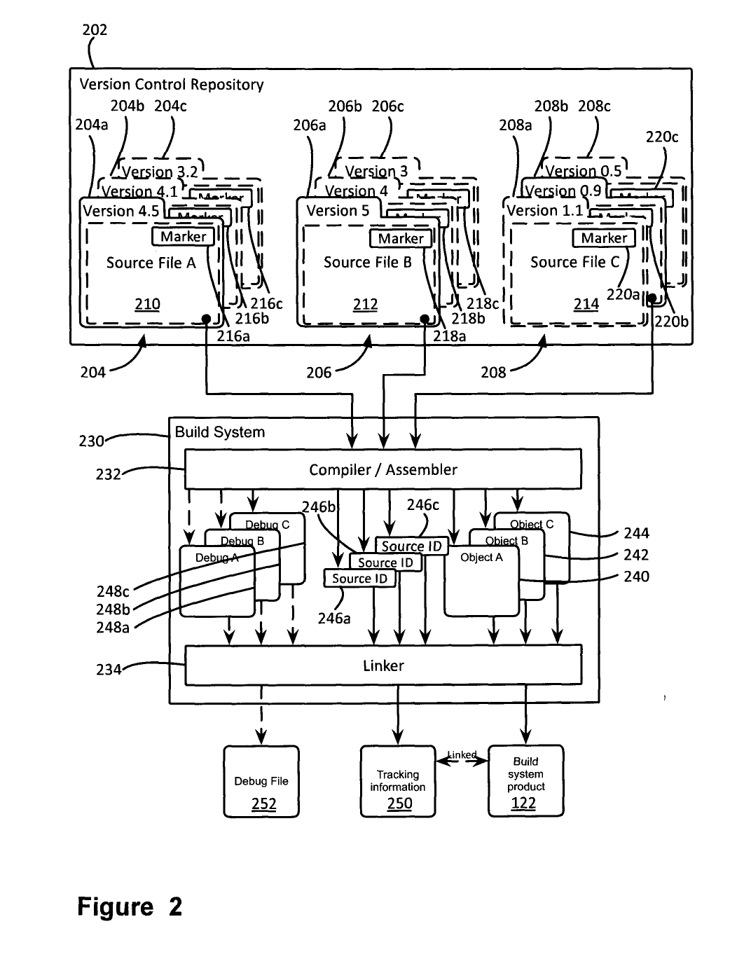

FIG. 2 depicts components of a system for generating compliance information. The system may include a version control repository (a.k.a. a version controlled source code repository) 202. The version control repository 202 may store a plurality of source code files 204, 206, 208. For each source code file 204, 206, 208, the version control repository 202 may store various different versions, for example 204a-c, 206a-c and 208a-c, of the source code files. A source code file 204, 206, 208, or source code file version, may include associated source code 210, 212, 214 and may also include compliance information identification. Each source code file may also include source code file identification markers, 216a-c, 218a-c, 220a-c. Each marker 216a-c, 218a-c, 220a-c provides for identification of the respective source code file by the build system 230. Each marker 216a-c, 218a-c, 220a-c may be embedded in the source code of the respective source code file version and may include identification of the source code file, by for example filename, pathname or universal resource locator (URL) and identification of the version of the source code file by for example version number. Each marker may be in the form of macro code embedded in the source code file. The macro code may be executable by the build system 230 during the build of the build-system product 122. An example macro follows that may be used by the build system 230 to obtain a URL to the source code file and a version number for the source code file that may be included in the respective Source ID 246 generated by the build system:

#if defined(_BUILD-SYSTEM-PRODUCT-NAME_)
&& defined(_USESRCVERSION)
#include <sys/srcversion.h>
_SRCVERSION(“$URL: http://??? $ $REV$”)
#endif

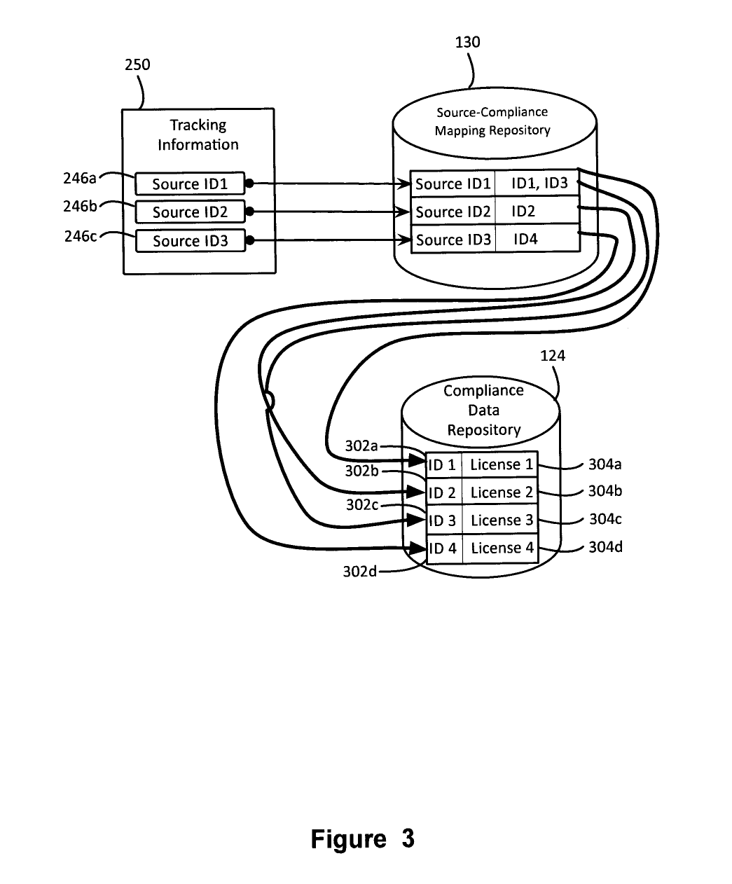

Referring to FIG. 3, the source-compliance mapping repository 130 may store one or more records that represent an association between a source code file identifier (e.g. Source ID 246) and one or more compliance information identifiers 302. Any source code file 118 may be associated with one or more compliance information date items and the corresponding record in the source-compliance mapping repository 130 may contain multiple compliance information identifiers 302. Source code file identifiers for source code files 118 that do not have associated compliance information need not appear in the source-compliance mapping repository 130. Each of one or more licensing records 304a-d stored in the compliance data repository 124 may store information associated with a compliance item such as a particular license. For example, one license record 304a may be associated with the GNU Public License (GPL) version2, another license record 304b may be associated with the GNU version3, another license 304c may be associated with the BSD license and another 304d may be associated with a commercial license. Each licensing record 304 may be accessed in the compliance data repository 124 using corresponding compliance information identifiers 302.

The system for generating compliance information further comprises a build system 230. The build system 230 may comprise a compiler/assembler 232 for compiling object files from source code files and a linker 234 for linking the compiled object files into a build-system product 122. The build system 230 may provide a plurality of files, including the build-system product 122 such as one or more of a processor executable file, a binary file, an object file, a static library file, and a linkable library file. The compiler/assembler 232 compiles the source code of the required source code file versions 204a, 206a, 208b. The compiler/assembler 232 output is stored into associated object files 240, 242, 244. The compiler/assembler 232 may also generate debug information 248a-c for the compiled object files 240, 242, 244. Tracking information 250 providing a source code identifier (a.k.a. source ID) 246a-c associated with each file used to generate the build-system product 122 is created and may be linked to the build-system product 122. The tracking information 250 may be embedded in the build-system product 122, embedded with a debug file 252, or provided in a separate file (as illustrated) as an output product of the build system 230. The tracking information 250 may be derived from the markers 216 included in the source code files 204, 206 and 208 used to build the build-system product. The markers 216 may include, for example, a macro that the build-system may use to generate a URL and version number for the respective source code file 204.

Once the compiler/assembler 232 generates the objects files 240, 242, 244, source IDs 246a-c and debug information 248a-c, the linker 234 may then generate the build-system product 122. The build-system product 122 may include a binary file, an object file, a static library file, and a linkable library file. The linker 234 may link the object files 240, 242, 244 into a build-system product 122, such as a binary file. The linker 234 may also embed the source ID 246a-c into a build-system product 122, or keep it as a separate tracking information 250 file. The tracking information 250 is associated with the generated build-system product 122 so that the source IDs 246a-c can be retrieved given the build-system product 122. The linker 234 may also generate a debug file 252 from the debug information 248a-c associated with the object files 240, 242, 244. The tracking information 250 may be associated with the build-system product 122 in various ways, such as embedding a common unique identifier in the tracking information 250 and/or build-system product 122, embedding the tracking information 250 within the build system product itself, embedding the tracking information in the associated debug file 252.

When a build-system product 122 is built from a subset of the source code files 204a, 206a, 208b stored in a source code file repository, the source code identifier, source id 246a-246c, for each of the files are associated with the resultant build-system product 122 in the tracking information 250. As a result, the compliance information 128 of the build-system product 122 can be determined using the source code identifiers, in the tracking information 250, to find the corresponding compliance identifiers 302 and license records 304 in the compliance data repository 124. Since the associated compliance information is associable with the build-system product 122, based on the source code files used in the build process, if a different source code file, or version of a source code file 204a, 206a, 208b, with different compliance information is included in a particular build of the build-system product 122, the tracking information 250 associated with the built build-system product 122 will reflect the different compliance information.

As describe above, the source ids 246a-c may be generated from a source code file location identifier, such as a Universal Resource Locator (URL) and a version identifier of the source code file. The source ids 246a-c may also be generated from a hash of the source code file location and the version identifier of the source code file. The source code file location identifier may also be encrypted and not directly resolvable within the tracking information 250. The source IDs 246a-c do not point directly to a compliance information record, but rather may be used to determined or identify a linking record that in turn specifies the compliance record or records associated with the particular source code file version such as, for example, records in source-compliance mapping repository 130.

Although specific components for generating the compliance information associated with a build-system product have been described above, it is contemplated that other implementations are possible. For example, determining the source identifiers associated with the source code files, object files or executable binaries used in building the build-system product, has been described as being performed by a complier or assembler; however, it is contemplated that the determination may be provided by a separate component. Similarly, the linking of the source identifiers into the tracking information associated with the build-system product has been described as being performed by a linker; however, it is contemplated that the linking of the tracking information and association with the build-system product may be performed by a separate component.

As will be appreciated, when building a build-system product, the linker may not have an explicit list of all files to include in building the build-system product. Rather, one or more files may be specified, and the linker determines which additional files are required by the specified one or more files. This process may continue until all of the files required to build the build-system product are included, for example, through the transitive closure of inter-file dependencies.

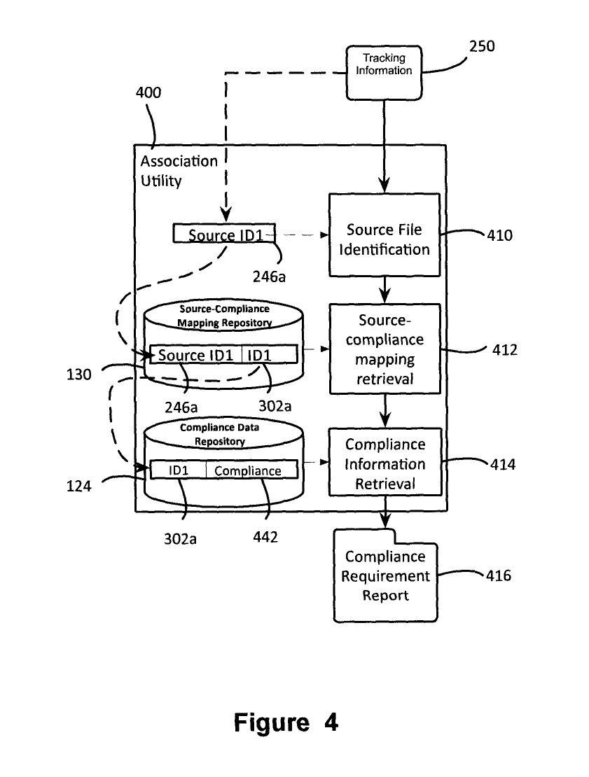

FIG. 4 depicts components of an association system (a.k.a. association utility) 400 for generating compliance information associated with a build-system product 122. As depicted the association system 400 receives tracking information 250 associated with a build-system product 122 such as a processor executable file, a binary file, an object file, a static library file, a linkable library file or a debug file. The build-system product 122 is associated with tracking information 250 as described above. The tracking information file 250 may be embedded in the actually binary file or linked by way of a unique tracking information 250 file identifier embedded in the files of the build-system product 122. The association system 400 receives the build-system product 122 and retrieves the tracking information 250 associated with the build-system product 122. From the tracking information 250, a source code file identification component 410 determines the source code file identifiers, such as for example a source code file identifier 246a, each of which identifies a source code file that contributed to generating the build-system product 122 from a source code file repository 116. Source-compliance mapping retrieval component 412 retrieves compliance information identifiers, such as for example compliance information identifier 302a, associated with each of the source code file identifiers. The determined compliance information identifiers are then used to determine the associated compliance information 442 from the compliance data repository 124 by a compliance information retrieval component 414. The compliance information retrieval component 414 may generate a compliance requirement report or compliance list 416, or other report, of the compliance information records retrieved from the compliance information repository 124. The compliance requirement report may comprise a software license guide for the build-system product.

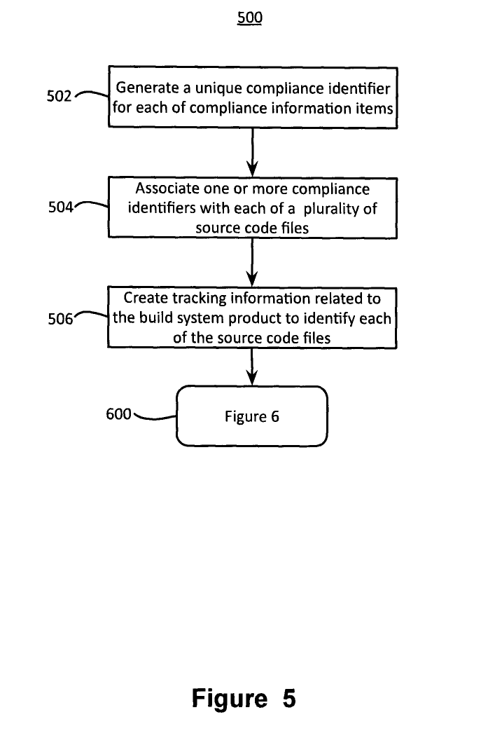

FIG. 5 depicts a method of associating compliance information from a plurality of source code files with a build-system product. A unique compliance identifier is generated for each compliance information item (502) in a compliance data repository 124. The compliance information items include any one or more of a software license agreement, software distribution restrictions, export restrictions, and an intellectual property rights identifier. One or more of the compliance identifiers are then associated with each of a plurality of source code files (504). The association may be captured, for example, in the source-compliance mapping repository 130 in records containing a source code identifier (Source ID) for a source code file and one or more corresponding associated compliance identifiers. The source code file 118, may comprise a source file, a header, a make file, a static library file or a linkable library file. Tracking information 250 is then be created related to a build-system product. The tracking information 250 may include a source code identifier for each of the plurality of source code files 118 that contribute to the building of the build-system product (506). For example the tracking information 250 may comprise a Universal Resource Locator (URL) and a version identifier for a source code file or a hash code used to identify the location of the source code file. The tracking information 250 may also be encrypted. The tracking information 250 may be contained in, or associated with, any one of a processor executable file, a binary file, an object file, a static library file, and a linkable library file.

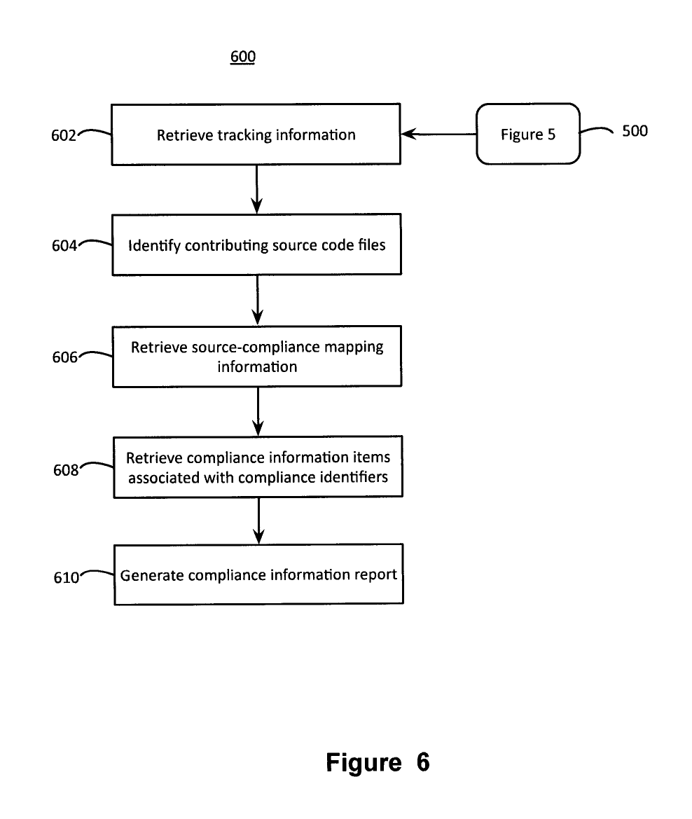

FIG. 6 depicts a method of generating compliance information associated with a build-system product. As described above, the generating of compliance information may comprise associating the compliance information from a plurality of source code files 118 used to build a build-system product 122. The generating of compliance information may further comprise generating the compliance information associated with a build-system product 122. The method 600 begins with retrieving tracking information 250 from the build-system product (602) or from a file associated with the build-system product 122. Contributing source code files 118 can then be identified (604) from the tracking information 250. Each of the source code files 118 may be identified in the tracking information 250 by a source code file identifier that uniquely identifies the file or the location of the file and may identify a version number of the file. The compliance identifiers associated with each of the source code files 118 may be retrieved from the source-compliance mapping repository 130 using the source code identifiers (606). The compliance information items 304 corresponding to the compliance identifiers may then be identified from the compliance data repository 124 and be utilized to generate a compliance information report (608).

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, and any suitable media that is fleeting and devoid of any semblance of permanence during transmission, and/or any suitable intangible media.

Although the description discloses example methods, system and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

1. A method, executable on one or more processors, for generating compliance information for a build-system product, the method comprising:
generating a unique compliance identifier for each of a plurality of compliance information items;
associating one or more compliance identifiers with each of a plurality of source code file identifiers and storing the associations in source-compliance mapping information;
creating tracking information related to the build-system product, the tracking information including a source code identifier for each of the plurality of source code files that contribute to the building of the build-system product; and
retrieving compliance information items for the build-system product using the tracking information and the source-compliance mapping information to identify the compliance information items associated with the plurality of source code files that contributed to the building of the build-system product.

2. The method of claim 1, where each of the plurality of compliance information items includes any one or more of: a software license agreement, software distribution restrictions, export restrictions, and an intellectual property rights identifier.

3. The method of claim 1, further comprising:
storing each of the plurality of compliance information items in a compliance information repository;
where each of the plurality of compliance information items is retrievable from the compliance information repository using the corresponding compliance identifier.

4. The method of claim 1, where the build-system product is any of: a processor executable file, a binary file, an object file, a static library file, and a linkable library file.

5. The method of claim 1, where the build-system product is built by a build system including any one or more of: a compiler, assembler and a linker.

6. The method of claim 1, where each source code identifier includes a source code file name identifier and a source code file version identifier.

7. The method of any one of claim 5, where the tracking information is created by the build system as a result of building the build-system product.

8. The method of claim 2, wherein the compliance information items are used to generate a software license guide for the build-system product.

9. The method of claim 1, where the tracking information is stored in a file related to the build-system product.

10. The method of claim 1, where each of the source code files comprises any of a source code file, a header file, a make file, a static library file or a linkable library file.

11. The method of claim 1 where each of the plurality of source code files identifiers is associated in a database with compliance identifiers, the compliance identifiers retrieved from the database to identify the associated compliance information items.

12. The method of claim 1, where each source code identifier comprises a hash code.

13. The method of claim 1, where each source code identifier is encrypted.

14. A system for generating compliance information for a build-system product, the system comprising:
a compliance information repository containing a plurality of compliance information items each retrievable using a unique compliance identifier;
a source code repository containing the plurality of source code files used for creating the build-system product;
a source-compliance mapping repository containing a plurality of records each associating a source code file identifier with one or more compliance identifiers and retrievable using the respective source code file identifier, where the one or more compliance identifiers in each record correspond to compliance information items associated with the source code file corresponding to the respective source code file identifier;
a build component creating tracking information related to the build-system product, the tracking information including a source code identifier for each of the plurality of source code files that contributes to the building of the build-system product; and
an association mechanism retrieving compliance information items for the build-system product using the tracking information and the source-compliance mapping repository records to identify the compliance information items associated with the plurality of source code files that contributed to the building of the build-system product.

15. The system of claim 14, where each of the plurality of compliance information items includes any one or more of: a software license agreement, software distribution restrictions, export restrictions, and an intellectual property rights identifier.

16. The system of claim 15 each of the plurality of compliance information items is stored in a compliance information repository and is retrievable from the compliance information repository using the corresponding compliance identifier.

17. The system of claim 16 where each of the plurality of source code file identifiers is associated in a database with the compliance identifiers, the compliance identifiers retrieved from the database to identify the associated compliance information items.

18. (canceled)

19. (canceled)

20. (canceled)

21. The system of claim 14, where the tracking information is created by the build component as a result of building the build-system product.

22. The system of any one of claim 21,
where the tracking information is embedded in the build-system product.

23. (canceled)

24. The system of claim 14, wherein the retrieved compliance information items are used to generate a software license guide for the build-system product.

25. (canceled)

26. (canceled)

27. (canceled)

28. A computer readable memory containing instructions for execution on one or more processors, the instructions for generating compliance information for a build-system product, the instructions comprising:
generating a unique compliance identifier for each of a plurality of compliance information items;
associating one or more compliance identifiers with each of a plurality of source code file identifiers and storing the associations in source-compliance mapping information;
creating tracking information related to the build-system product, the tracking information including a source code identifier for each of the plurality of source code files that contribute to the building of the build-system product: and
retrieving compliance information items for the build-system product using the tracking information and the source-compliance mapping information to identify the compliance information items associated with the plurality of source code files that contributed to the building of the build-system product.
